(19) United States
(12) Patent Application Publication
(10) Pub. No.: US 2017/0026534 A1
(43) Pub. Date: Jan. 26, 2017

(54) MANAGEMENT DEVICE, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Yosuke KINOSHITA, Kanagawa (JP)

(73) Assignee: FUJI XEROX CO., LTD., Tokyo (JP)

(21) Appl. No.: 14/992,676

(22) Filed: Jan. 11, 2016

(30) Foreign Application Priority Data
Jul. 24, 2015 (JP) 2015-147053

(51) Int. Cl. H04N 1/00

(52) U.S. Cl. CPC H04N 1/00952; H04N 1/00127; H04N 2201/0044

(57) ABSTRACT

A management device includes an output unit. The output unit outputs, in a case where any first function has been added among plural types of first function to an information processing device, information representing a second function obtained by excluding, from plural second functions that have become available by this addition, a second function that has been added to the information processing device, the information processing device being an information processing device to which it is possible to add the plural types of first function and the plural types of second function, the plural types of second function including a second function that becomes available in a case where any of the plural types of first function has been added.

### CROSS-REFERENCE TO RELATED APPLICATIONS

This application is based on and claims priority under 35 USC 119 from Japanese Patent Application No. 2015-147053 filed Jul. 24, 2015.

### BACKGROUND

### Technical Field

The present invention relates to a management device, an information processing system, and a non-transitory computer readable medium.

### SUMMARY

According to an aspect of the invention, there is provided a management device including an output unit. The output unit outputs, in a case where any first function has been added among plural types of first function to an information processing device, information representing a second function obtained by excluding, from plural second functions that have become available by this addition, a second function that has been added to the information processing device, the information processing device being an information processing device to which it is possible to add the plural types of first function and the plural types of second function, the plural types of second function including a second function that becomes available in a case where any of the plural types of first function has been added.

### BRIEF DESCRIPTION OF THE DRAWINGS

An exemplary embodiment of the present invention will be described in detail based on the following figures, wherein:

FIG. 1 is a diagram illustrating the entire configuration of an information processing system according to an exemplary embodiment;

FIG. 2 is a diagram illustrating a hardware configuration of an image processing device;

FIG. 3 is a diagram illustrating a hardware configuration of a store server device;

FIG. 4 is a diagram illustrating a hardware configuration of a user device;

FIG. 5 is a diagram illustrating a functional configuration of the information processing system;

FIG. 6 is a diagram illustrating an example of a list of added plug-ins;

FIG. 7 is a diagram illustrating an example of a list of added options;

FIG. 8 is a diagram illustrating an example of function information;

FIG. 9 is a diagram illustrating an example of added-plug-in information;

FIG. 10 is a diagram illustrating an example of added-option information;

FIG. 11 is a diagram illustrating an example of last-time added-option information;

FIG. 12 is a diagram illustrating an example of necessary-option information;

FIG. 13 is a diagram illustrating a diagram used to describe a method for determining newly available plug-ins;

FIGS. 14A and 14B are diagrams illustrating examples of a displayed screen of a certain selling site;

FIG. 15 is a diagram illustrating an example of an operation procedure of each device of the information processing system;

FIG. 16 is a diagram illustrating another example of an operation procedure of each device of the information processing system;

FIG. 17 is a diagram illustrating an example an operation procedure in a process for determining newly available plug-ins;

FIG. 18 is a diagram illustrating details of an operation procedure from steps S11 to S14;

FIG. 19 is a diagram illustrating details of an operation procedure from steps S15 to S18;

FIG. 20 is a diagram illustrating an example of an output-method table;

FIG. 21 is a diagram illustrating another example of an output-method table;

FIG. 22 is a diagram illustrating another example of an output-method table;

FIG. 23 is a diagram illustrating an example of the entire configuration of an information processing system according to a modification;

FIG. 24 is a diagram illustrating another example of an output-method table; and

FIG. 25 is a diagram illustrating an example of a screen displaying necessary-option information.

### DETAILED DESCRIPTION

### [1] Exemplary Embodiment

### [1-1] Configuration

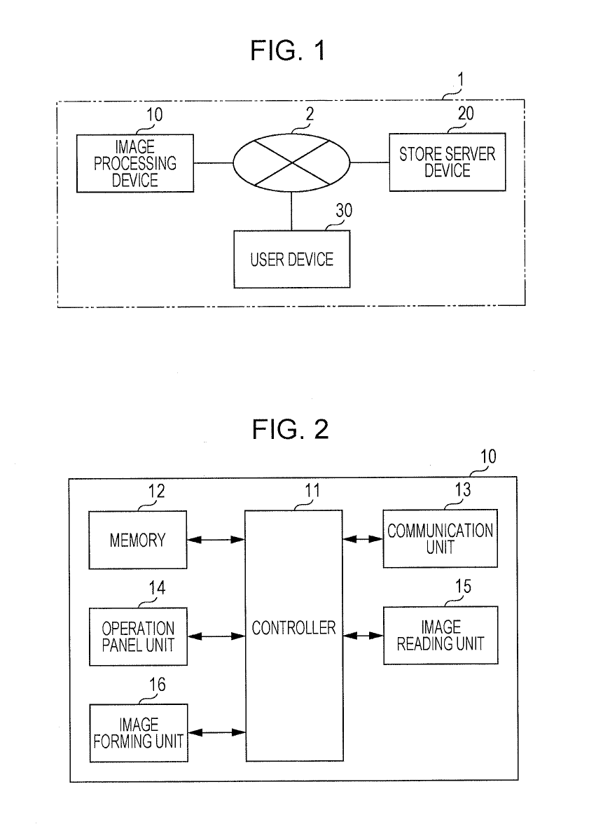

FIG. 1 illustrates the entire configuration of an information processing system 1 according to an exemplary embodiment. The information processing system 1 includes a communication line 2, an image processing device 10, a store server device 20, and a user device 30. The communication line 2 includes, for example, the Internet, a mobile telecommunications network, a telephone line, and the like, and relays communication between devices connected thereto. The image processing device 10, the store server device 20, and the user device 30 are connected to the communication line 2.

The image processing device 10 is a device that performs processes such as an image forming process for forming an image on a medium and an image reading process for reading an image formed on a medium, and is an example of an “information processing device” according to the exemplary embodiment of the present invention. It is possible to additionally add options to the image processing device 10. An option is a function realized by a hardware device, a software program, or both. An option is an example of a “first function” according to the exemplary embodiment of the present invention.

It is possible to add to the image processing device 10 plural types of option, examples of which are a scan option for enabling reading of images, an optical character recognition (OCR) option for enabling character recognition, an memory add-on option for enabling enlargement of the size of a storage area, a FAX option for enabling use of a FAX, and a customized option for enabling user authentication unique to each client.

In addition, other than options, it is possible to additionally add plug-ins to the image processing device 10. A plug-in is a function realized by a software program itself, or both of a software program and a hardware device, and is able to be added afterwards similarly to options. A plug-in is an example of a “second function” according to the exemplary embodiment of the present invention. It is possible to add to the image processing device 10 plural types of plug-in, examples of which are a translation service for translating scanned characters, the above-described customized authentication for enabling user authentication unique to each client, cloud printing for printing documents stored in cloud servers, cloud storage provided by cloud computing, and a FAX function for enabling use of a FAX with a simple operation.

The plural types of plug-in include a plug-in that becomes available when any of the plural types of option has been added. For example, the translation service is available when the “scan option”, the “OCR option”, and the “memory add-on option” have been added among the options. Specifically, the image processing device 10 reads an image of sentences from a document using the scan option, recognizes characters of the sentences illustrated in the image read using the OCR option, uses a memory added using the memory add-on option as a work area, and consequently translates the scanned sentences using the translation service.

The above-described options and plug-ins are sold in various ways such as at shops, selling sites on the Internet, and the like; however, a description will be made assuming that any of the options and plug-ins is sold at a certain selling site in the present exemplary embodiment. In this case, an option is purchased by a user from the certain selling site, and is added to the image processing device 10 by the user or a certain operator performing operations such as setting up of a hardware device, and download, installation, and setting of a software program. In addition, a plug-in is added to the image processing device 10 by the user performing operations such as download of the plug-in from the selling site, and installation and setting of the plug-in.

The store server device 20 is a device that realizes the above-described selling site. The store server device 20 stores options and plug-ins realized by software programs. The store server device 20 distributes a web page for using the selling site. When the user performs an operation for purchasing a plug-in to be added to the image processing device 10, for example, on the web page, the store server device 20 transmits the purchased plug-in to the image processing device 10 (namely, the store server device 20 causes the image processing device 10 to download the plug-in).

In addition, the store server device 20 manages information regarding options and plug-ins that have been added to the image processing device 10. Since the store server device 20 performs this management, it may be prevented that options and plug-ins that have been added are purchased redundantly. The store server device 20 is an example of a “management device” according to the exemplary embodiment of the present invention.

The user device 30 is a device used by a user, and is for example a personal computer. The user operates the user device 30 and causes the web page distributed by the store server device 20 to be displayed. The user performs an operation for purchasing an option and a plug-in described above and an operation for adding the option and the plug-in to the image processing device 10.

FIG. 2 illustrates a hardware configuration of the image processing device 10. The image processing device 10 is a computer including a controller 11, a memory 12, a communication unit 13, an operation panel unit 14, an image reading unit 15, and an image forming unit 16. The controller 11 includes a central processing unit (CPU), a read-only memory (ROM), a random-access memory (RAM), and a real-time clock. The controller 11 controls operations of units by using the CPU using the RAM as a work area and executing programs stored in the ROM and the memory 12. The real-time clock calculates the current date and time, and notifies the CPU of the current date and time. The memory 12 includes, for example, a hard disk, and stores data and programs used to perform control by the controller 11.

The communication unit 13 includes, for example, a circuit used to perform wired communication, and performs communication via the communication line 2. The operation panel unit 14 is a user interface used by the user operating the image processing device 10. The operation panel unit 14 has, for example, a liquid crystal display, and a touch sensor (also referred to as a touch screen or a touch panel) provided so as to overlie a display surface of the liquid crystal display. The operation panel unit 14 displays images on the display surface under control of the controller 11, receives an operation performed by the user such as tapping on the touch sensor, and supplies operation data indicating the content of the operation to the controller 11. The controller 11 performs control in accordance with supplied operation data.

The image reading unit 15 optically reads images formed on mediums such as paper sheets using, for example, a charge coupled device (CCD) system, and supplies image data representing the read images to the controller 11. The image forming unit 16 forms images represented by image data supplied from the controller 11 on mediums such as paper sheets using, for example, an electrophotographic system. Note that the above-described systems used for reading and forming images are examples, and other systems may also be used.

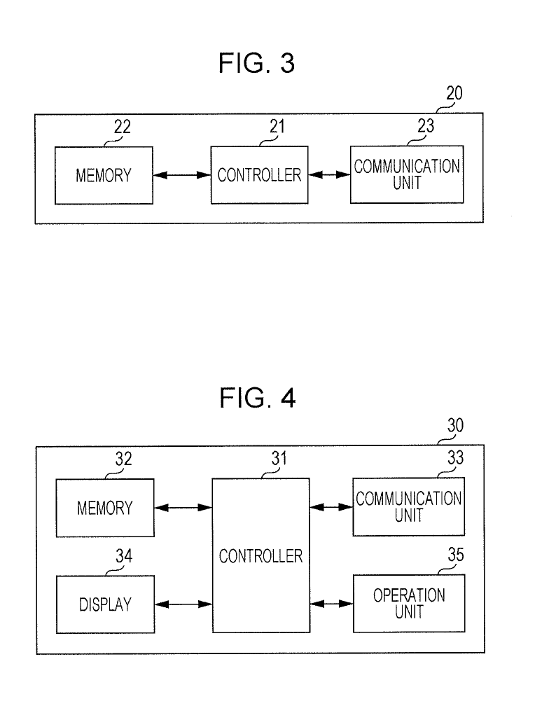

FIG. 3 illustrates a hardware configuration of the store server device 20. The store server device 20 is a computer including a controller 21, a memory 22, and a communication unit 23. These units are the same types of hardware device as the units illustrated in FIG. 2 and having the same names as these units, and thus description thereof will be omitted.

FIG. 4 illustrates a hardware configuration of the user device 30. The user device 30 is a computer including a controller 31, a memory 32, a communication unit 33, a display 34, and an operation unit 35. The controller 31, the memory 32, and the communication unit 33 are the same types of hardware device as the units illustrated in FIG. 2 and having the same names as these units, and thus description thereof will be omitted. The display 34 has, for example, a liquid crystal display, and displays images on a display surface of the liquid crystal display under control of the controller 31. The operation unit 35 includes, for example, a keyboard and a mouse. The operation unit 35 receives an operation performed by the user, and supplies operation data indicating the content of the operation to the controller 31.

The controllers of the image processing device 10, the store server device 20, and the user device 30 execute programs and control various units. Consequently, functions to be described below are realized.

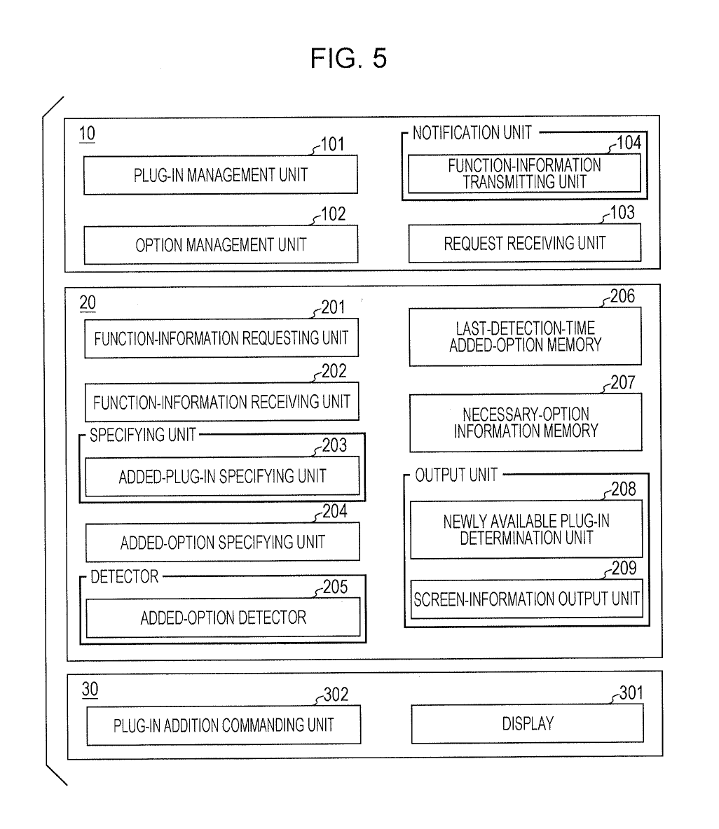

FIG. 5 illustrates a functional configuration of the information processing system 1. The image processing device 10 includes a plug-in management unit 101, an option management unit 102, a request receiving unit 103, and a function-information transmitting unit 104. The store server device 20 includes a function-information requesting unit 201, a function-information receiving unit 202, an added-plug-in specifying unit 203, an added-option specifying unit 204, an added-option detector 205, a last-detection-time added-option memory 206, a necessary-option information memory 207, a newly available plug-in determination unit 208, and a screen-information output unit 209. The user device 30 includes a display 301 and a plug-in addition commanding unit 302.

The plug-in management unit 101 of the image processing device 10 manages plug-ins that have already been added to the image processing device 10 (namely, added plug-ins) and information regarding these plug-ins. When a plug-in is added to the image processing device 10, the plug-in management unit 101 adds information used to identify the plug-in to a list of added plug-ins.

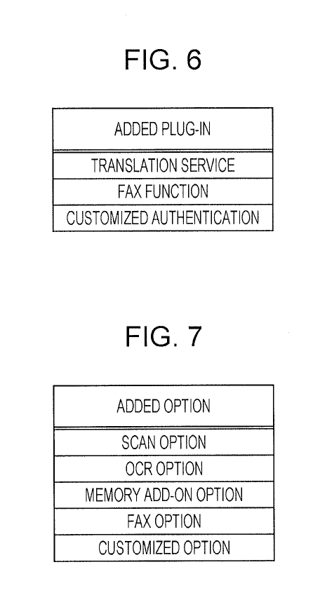

FIG. 6 illustrates an example of a list of added plug-ins. The example illustrated in FIG. 6 shows a list of added plug-ins including, as added plug-ins, character strings of “translation service”, “FAX function”, and “customized authentication”. These character strings represent names of plug-ins, and are an example of information used to identify the plug-ins.

The option management unit 102 of the image processing device 10 manages options that have been added to the image processing device 10, and information regarding these options. When an option is added to the image processing device 10, the option management unit 102 adds the option to a list of added options.

FIG. 7 illustrates an example of a list of added options. The example illustrated in FIG. 7 shows a list of added options including, as added options, character strings of “scan option”, “OCR option”, “memory add-on option”, “FAX option”, and “customized option”. These character strings represent names of options, and are an example of information used to identify the options.

The list of added plug-ins and the list of added options are stored in the memory 12 illustrated in FIG. 2 in the present exemplary embodiment. Note that where these lists are stored is not limited to the memory 12, and may also be stored in an external storage device. In addition, other than the names illustrated in FIG. 6 and FIG. 7, for example, IDs assigned to plug-ins and options may also be used as information used to identify the plug-ins and the options.

The function-information requesting unit 201 of the store server device 20 requests function information from the image processing device 10. Function information is information representing functions including options and plug-ins added to a target device (the image processing device 10 in this example). The function-information requesting unit 201 issues a function-information request by transmitting request data to the image processing device 10, the request data requesting transmission of function information to the store server device 20.

The request receiving unit 103 of the image processing device 10 receives a function-information request issued thereto. By receiving request data transmitted from the store server device 20, the request receiving unit 103 receives a function-information request represented by this request data. Upon receiving this request, the request receiving unit 103 notifies the function-information transmitting unit 104 that the request has been received and of address information regarding a request source (for example, an Internet Protocol (IP) address).

The function-information transmitting unit 104 of the image processing device 10 transmits, to the request source (the store server device 20 in the present exemplary embodiment), function information a request for which has been received by the request receiving unit 103. Upon being notified by the request receiving unit 103 that a function-information request has been received, the function-information transmitting unit 104 reads out the above-described list of added plug-ins and list of added options, generates function information representing added plug-ins and added options, and transmits the function information to the store server device 20, which is the request source.

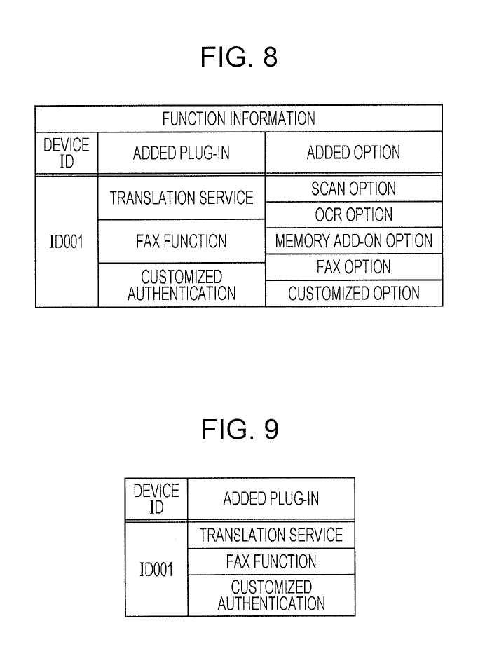

FIG. 8 illustrates an example of function information. The example illustrated in FIG. 8 shows function information. In the function information, the added plug-ins illustrated in FIG. 6 and the added options illustrated in FIG. 7 are associated with “ID001”, which is a device identification (ID) assigned to the image processing device 10. Here, the added plug-ins illustrated in FIG. 6 are the “translation service”, the “FAX function”, and the “customized authentication”, and the added options illustrated in FIG. 7 are the “scan option”, the “OCR option”, the “memory add-on option”, the “FAX option”, and the “customized option”. This function information is transmitted, and the store server device 20 is notified of the options added to the image processing device 10 among plural types of option. The function-information transmitting unit 104 is an example of a “notification unit” according to the exemplary embodiment of the present invention.

The function-information receiving unit 202 of the store server device 20 receives function information transmitted from the image processing device 10. The function-information receiving unit 202 supplies the received function information to the added-plug-in specifying unit 203 and the added-option specifying unit 204.

The added-plug-in specifying unit 203 of the store server device 20 specifies, among plural types of plug-in, plug-ins that have already been added to the image processing device 10 (namely, added plug-ins). The added-plug-in specifying unit 203 is an example of a “specifying unit” according to the exemplary embodiment of the present invention. The added-plug-in specifying unit 203 specifies plug-ins indicated by function information supplied from the function-information receiving unit 202, as plug-ins that have been added to the image processing device 10. The added-plug-in specifying unit 203 stores added-plug-in information representing the specified added plug-ins so that the added-plug-in information is associated with the device ID of the image processing device 10.

FIG. 9 illustrates an example of added-plug-in information. The example illustrated in FIG. 9 shows added-plug-in information including names of “translation service”, “FAX function”, and “customized authentication”, which are the added plug-ins illustrated in FIG. 6. In order to clarify a device to which the plug-ins have been added, these plug-in names are associated with “ID001”, which is the device ID of the image processing device 10, in this added-plug-in information.

The added-option specifying unit 204 of the store server device 20 specifies, among plural types of option, options that have been added to the image processing device 10 (namely, added options). The added-option specifying unit 204 specifies options indicated by function information supplied from the function-information receiving unit 202, as options that have been added to the image processing device 10. The added-option specifying unit 204 stores added-option information representing the specified added options so that the added-option information is associated with the device ID of the image processing device 10.

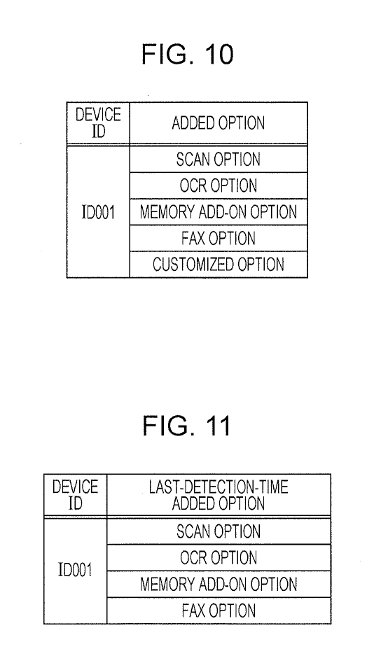

FIG. 10 illustrates an example of added-option information. The example illustrated in FIG. 10 shows added-option information including names of “scan option”, “OCR option”, “memory add-on option”, “FAX option”, and “customized option”, which are the added options illustrated in FIG. 7. In order to clarify a device to which the options have been added similarly to as in the above-described added-plug-in information, these option names are associated with “ID001”, which is the device ID of the image processing device 10, in this added-option information.

In the case where any option among plural types of option has been added to the image processing device 10, the added-option detector 205 of the store server device 20 detects the added option (hereinafter referred to as “added option”). The added-option detector 205 is an example of a “detector” according to the exemplary embodiment of the present invention. The added-option detector 205 detects an added option in accordance with information stored in the added-option specifying unit 204 (the above-described added-option information) and information stored in the last-detection-time added-option memory 206.

When the added-option detector 205 detects an added option, the last-detection-time added-option memory 206 of the store server device 20 reads out the added-option information stored in the added-option specifying unit 204 and stores the added-option information. As a result, the last-detection-time added-option memory 206 stores last-time added-option information indicating options that have been added to the image processing device 10 at the time of the last added-option detection performed by the added-option detector 205.

FIG. 11 illustrates an example of last-time added-option information. The example illustrated in FIG. 11 shows information in which the “scan option”, the “OCR option”, the “memory add-on option”, and the “FAX option” are associated with a device ID of “ID001”. The added-option detector 205 detects, as added options, options obtained by excluding options included in the last-time added-option information stored in the last-detection-time added-option memory 206 from options included in the added-option information stored in the added-option specifying unit 204. In the examples illustrated in FIGS. 9 and 11, the added-option detector 205 detects the “customized option”, which is included in FIG. 9 but not included in FIG. 11, as an added option.

The necessary-option information memory 207 of the store server device 20 stores information representing necessary options to use plug-ins (hereinafter referred to as “necessary-option information”).

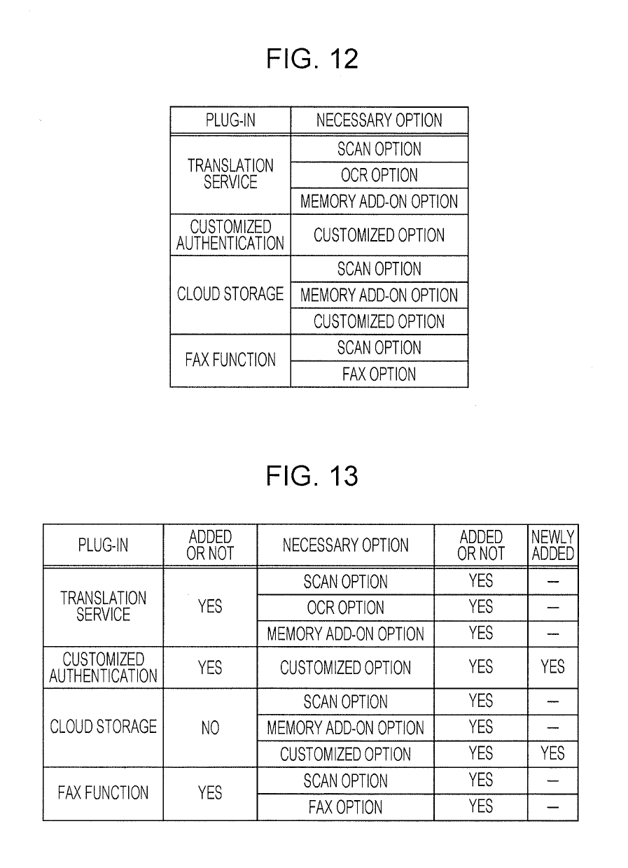

FIG. 12 illustrates an example of necessary-option information. The example illustrated in FIG. 12 shows that the options necessary for the plug-in called “translation service” are the “scan option”, the “OCR option”, and the “memory add-on option”, and the option necessary for the plug-in called “customized authentication” is the “customized option”. In addition, the example illustrated in FIG. 12 shows that the options necessary for the plug-in called “cloud storage” are the “scan option”, the “memory add-on option”, and the “customized option”, and the options necessary for the plug-in called “FAX function” are the “scan option” and the “FAX option”.

The newly available plug-in determination unit 208 of the store server device 20 determines plug-ins that become newly available by addition of an added option detected by the added-option detector 205. The newly available plug-in determination unit 208 performs a determination using, for example, the necessary-option information illustrated in FIG. 12.

FIG. 13 illustrates a diagram used to describe a method for determining newly available plug-ins. In FIG. 13, added plug-ins have “yes” in a column of “added or not”, and not-added plug-ins have “no” in this column among plural types of plug-in included in the necessary-option information. In addition, added options have “yes” in a column of “added or not”, and not-added options have “no” in this column among the necessary options (since all the options have been added, all the options have “yes” in this example). In addition, options determined to be added options have “yes” in a column of “newly added”, and others have “-” in this column among the necessary options.

The example illustrated in FIG. 13 shows that only the plug-in called “cloud storage” is not added, and the necessary option called “customized option” has been newly added. The newly available plug-in determination unit 208 specifies, among four types of plug-in illustrated in FIG. 13, plug-ins whose corresponding necessary options have all “yes” in the column of “added or not” and include a necessary option having “yes” in the column of “newly added”. In this case, the “customized authentication” and the “cloud storage”, which include the “customized option” as a necessary option, are specified. The two plug-ins specified in this manner are plug-ins that have become available by addition of an added option.

The newly available plug-in determination unit 208 determines, to be newly available plug-ins, plug-ins (the “cloud storage” in this example) obtained by excluding plug-ins having an addition-completed flag of “yes” (that is, plug-ins specified as added plug-ins by the added-plug-in specifying unit 203) from plug-ins specified as above (plug-ins that have become available by addition of an added option, which are the “customized authentication” and the “cloud storage” in this example). The newly available plug-in determination unit 208 notifies the screen-information output unit 209 of the determined plug-ins.

The screen-information output unit 209 of the store server device 20 outputs screen information representing a screen of a certain selling site. Screen information is, for example, a Hypertext Markup Language (HTML) document representing a web page. The screen-information output unit 209 outputs, for example, screen information indicating a list of added plug-ins specified by the added-plug-in specifying unit 203. In addition, the screen-information output unit 209 outputs screen information indicating plug-ins determined by the newly available plug-in determination unit 208 to be newly available plug-ins, that is, plug-ins that have become available by addition of added options. The newly available plug-in determination unit 208 and the screen-information output unit 209 are examples of an “output unit” according to the exemplary embodiment of the present invention.

The screen-information output unit 209 outputs screen information to, for example, the user device 30 accessing the store server device 20. The display 301 of the user device 30 displays a screen of the certain selling site represented by the screen information output from the store server device 20.

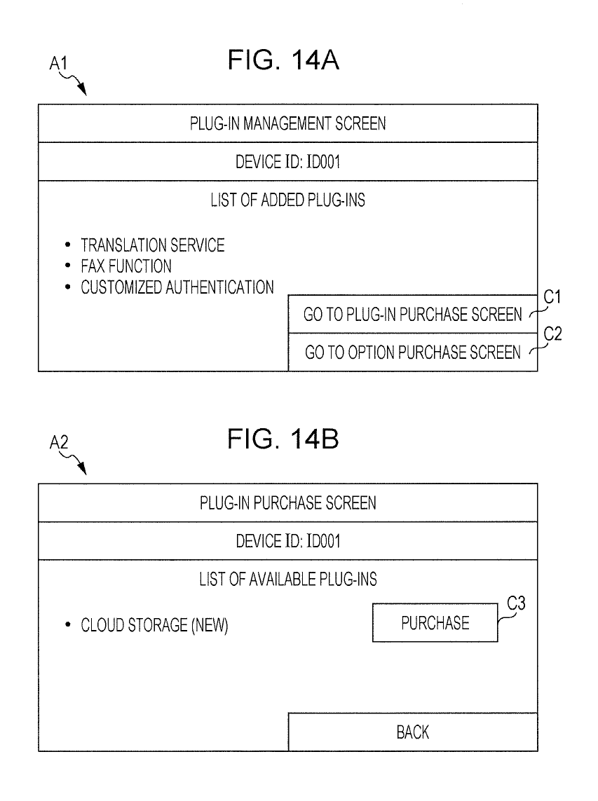

FIGS. 14A and 14B illustrate examples of a displayed screen of the certain selling site. FIG. 14A illustrates a screen A1 titled “plug-in management screen”. The screen A1 displays a list of plug-ins added to the image processing device 10 (the “translation service”, the “FAX function”, and the “customized authentication” in this example). A character string of “device ID: ID001” displayed on the screen A1 indicates that these plug-ins are added to the image processing device 10. The screen A1 displays an operator C1 including characters “go to plug-in purchase screen”, and an operator C2 including characters “go to option purchase screen”.

FIG. 14B displays a screen A2 titled “plug-in purchase screen”, which is displayed when the operator C1 is operated. The screen A2 displays a list of plug-ins available for the image processing device 10 (the “cloud storage” in this example). Characters “New” to the right of a plug-in indicate that the plug-in has become newly available. An operator C3 including characters “purchase” to the further right of the plug-in is displayed. License rights (a license) of the plug-in “cloud storage” are purchased by the user operating this operator C3.

The plug-in addition commanding unit 302 of the image processing device 10 commands addition of a plug-in purchased from the selling site to the image processing device 10. For example, when the operator C3 illustrated in FIG. 14B is operated, the plug-in addition commanding unit 302 commands the store server device 20 to transmit the plug-in whose license has been purchased through this operation performed on the operator C3, and commands the image processing device 10 to install the plug-in transmitted from the store server device 20 into the image processing device 10. In addition, for example, when the user performs an operation for initial settings, the plug-in addition commanding unit 302 commands the image processing device 10 to reflect the initial settings. Note that commands to the image processing device 10 may be issued via the store server device 20.

### [1-2] Operation

In the following, operations performed by the devices of the information processing system 1 will be described.

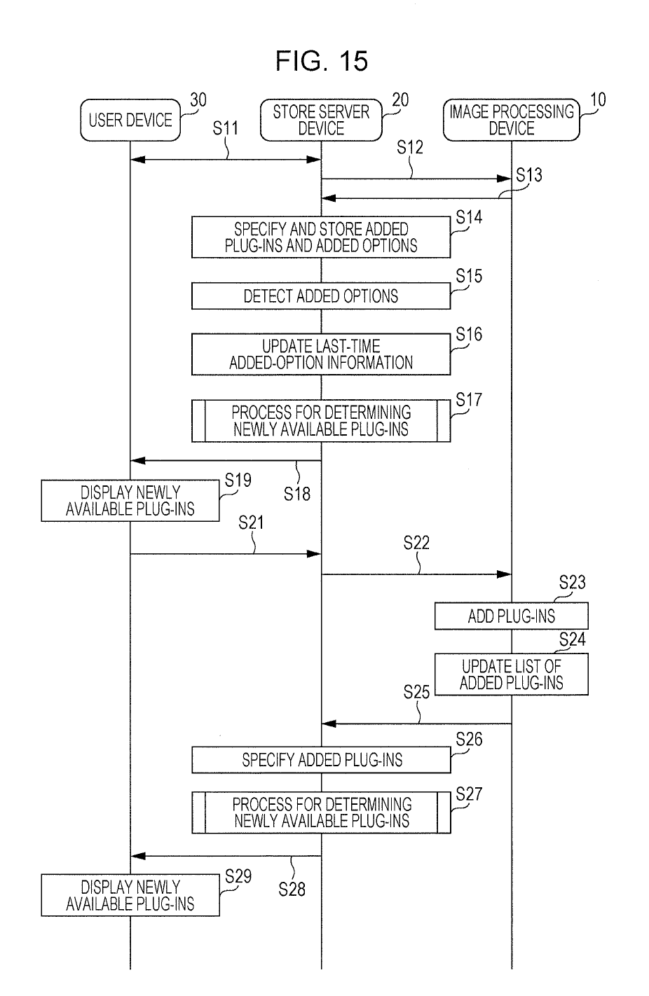

FIG. 15 illustrates an example of an operation procedure of each device of the information processing system 1. FIG. 15 illustrates an example of an operation procedure regarding display of a screen showing available plug-ins and addition of a plug-in.

First, when the user performs an operation for logging in to a certain selling site and an operation for causing a screen to be displayed, the screen being used to purchase a plug-in for the image processing device 10, the user device 30 requests the store server device 20 to display the screen after communicating about information such as a user ID and a password with the store server device 20 (step S11). The store server device 20 (the function-information requesting unit 201) requests function information from the image processing device 10 (step S12). Upon receiving the request, the image processing device 10 (the plug-in management unit 101, the option management unit 102, the request receiving unit 103, and the function-information transmitting unit 104) generates function information (for example, the information illustrated in FIG. 8), and transmits the function information to the store server device 20 (step S13).

Upon receiving the function information, the store server device 20 (the function-information receiving unit 202, the added-plug-in specifying unit 203, and the added-option specifying unit 204) specifies added plug-ins and added options in accordance with the function information, and stores added-plug-in information (for example, the information illustrated in FIG. 9) and added-option information (for example, the information illustrated in FIG. 10) (step S14). Next, the store server device 20 (the added-option detector 205) detects added options in accordance with the added-option information and last-time added-option information (for example, the information illustrated in FIG. 11) (step S15). Next, the store server device 20 (the last-detection-time added-option memory 206) updates the last-time added-option information using the added-option information stored in step S14 (step S16).

Next, the store server device 20 (the newly available plug-in determination unit 208) performs a process for determining newly available plug-ins. In the process, plug-ins (newly available plug-ins) are determined that have become available by addition of detected added options, in accordance with a detection result obtained in step S15 and the added-plug-in information stored in step S14 (step S17). Then, the store server device 20 (the screen-information output unit 209) outputs, to the user device 30, screen information indicating newly available plug-ins that have been determined (step S18). The user device 30 (the display 301) displays newly available plug-ins indicated by the screen information output from the store server device 20 (step S19).

When the user performs an operation for adding a newly available plug-in among the newly available plug-ins displayed in step S19, the user device 30 (the plug-in addition commanding unit 302) requests the store server device 20 to transmit the newly available plug-in to the image processing device 10 (step S21). The store server device 20 transmits, to the image processing device 10, the newly available plug-in, which has been requested, and also commands the image processing device 10 to install the newly available plug-in (step S22). The image processing device 10 installs the newly available plug-in, which has been transmitted from the store server device 20, thereinto in accordance with this command (step S23).

Next, the image processing device 10 (the plug-in management unit 101) updates a list of added plug-ins (step S24). Then, the image processing device 10 (the function-information transmitting unit 104) transmits, to the store server device 20, function information generated in accordance with the updated list of added plug-ins (step S25). The store server device 20 (the added-plug-in specifying unit 203) specifies added plug-ins in accordance with the received function information, and stores added-plug-in information (step S26). Next, the store server device 20 (the newly available plug-in determination unit 208) performs the process for determining newly available plug-ins, which is the same as step S17, in accordance with the updated added-plug-in information (step S27).

Then, the store server device 20 (the screen-information output unit 209) outputs, to the user device 30, screen information indicating newly available plug-ins, which have been determined, (step S28). The user device 30 (the display 301) displays the newly available plug-ins indicated by the screen information output from the store server device 20 (step S29). The newly available plug-ins displayed here are plug-ins obtained by excluding the plug-in added in step S23 from the newly available plug-ins displayed in step S19.

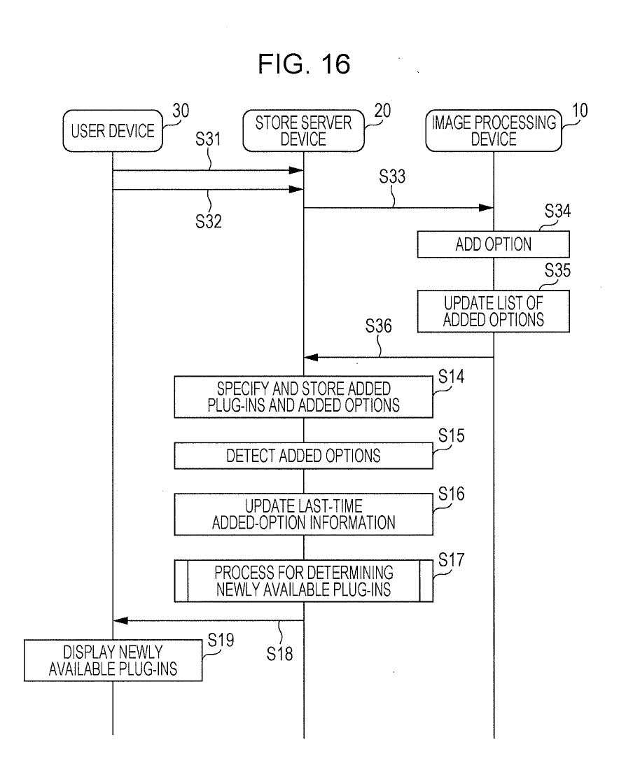

FIG. 16 illustrates another example of an operation procedure of each device of the information processing system 1. FIG. 16 illustrates an operation procedure regarding addition of a plug-in in a case where an option is purchased. In this example, an option realized by a software program is downloaded from the store server device 20, and added to the image processing device 10. First, when the user performs an operation for purchasing a certain option for the image processing device 10 and an operation for requesting addition of the option, the user device 30 notifies the store server device 20 of an option to be purchased (step S31), and requests the store server device 20 to transmit the option to the image processing device 10 (step S32).

The store server device 20 commands the image processing device 10 to transmit the option, for which a notification has been made, and install the option (step S33). The image processing device 10 adds the option transmitted from the store server device 20 thereto in accordance with this command (step S34). Next, the image processing device 10 (the option management unit 102) updates a list of added options (step S35). Then, the image processing device 10 (the function-information transmitting unit 104) transmits, to the store server device 20, function information generated in accordance with the updated list of added options (step S36). Thereafter, the operation from steps S14 to S19 illustrated in FIG. 15 is performed, and newly available plug-ins are displayed at the user device 30.

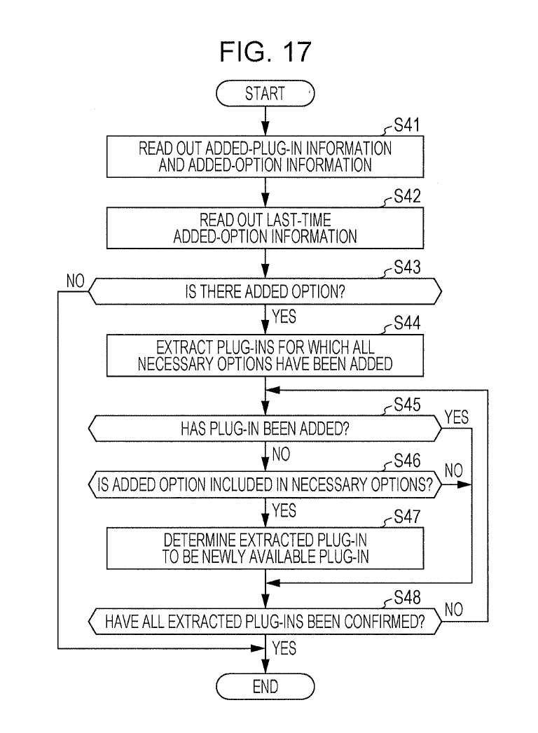

FIG. 17 illustrates an example an operation procedure performed in the process for determining newly available plug-ins. The store server device 20 first reads out the stored added-plug-in information and the stored added-option information (step S41), and also reads out the stored last-time added-option information (step S42). Next, the store server device 20 determines whether or not there are added options in accordance with the read-out pieces of information (step S43). In the case where it is determined that there is no added option (NO in step S43), this operation procedure ends.

In the case where it is determined in step S43 that there is an added option (YES in step S43), the store server device 20 extracts plug-ins for which all the necessary options have been added (step S44). For each of the extracted plug-ins, the store server device 20 performs an operation from steps S45 to S47. First, the store server device 20 determines whether or not the extracted plug-in has been added (step S45). When it is determined that the extracted plug-in has not been added (NO in step S45), the store server device 20 determines whether or not the necessary options of the extracted plug-in include the added option (step S46). In the case where it is determined that the necessary options of the extracted plug-in include the added option (YES in step S46), the store server device 20 determines the extracted plug-in to be a newly available plug-in (step S47).

The store server device 20 determines whether or not steps S45 and S46 have been confirmed for all the extracted plug-ins (step S48). In the case where it is determined that confirmation has been done (YES in step S48), this operation procedure ends. In the case where it is determined that there are plug-ins for which confirmation has not been done (NO in step S48), the process returns to step S45 and continues. In addition, in the case where it is determined in step S45 that the extracted plug-in has been added (YES in step S45) and the case where it is determined in step S46 that the necessary options of the extracted plug-in do not include the added option (NO in step S46), the store server device 20 performs the operation for step S48. In this manner, a determination is performed as to whether or not each of the plug-ins extracted in step S44, for which all the necessary options have been added, is a newly available plug-in.

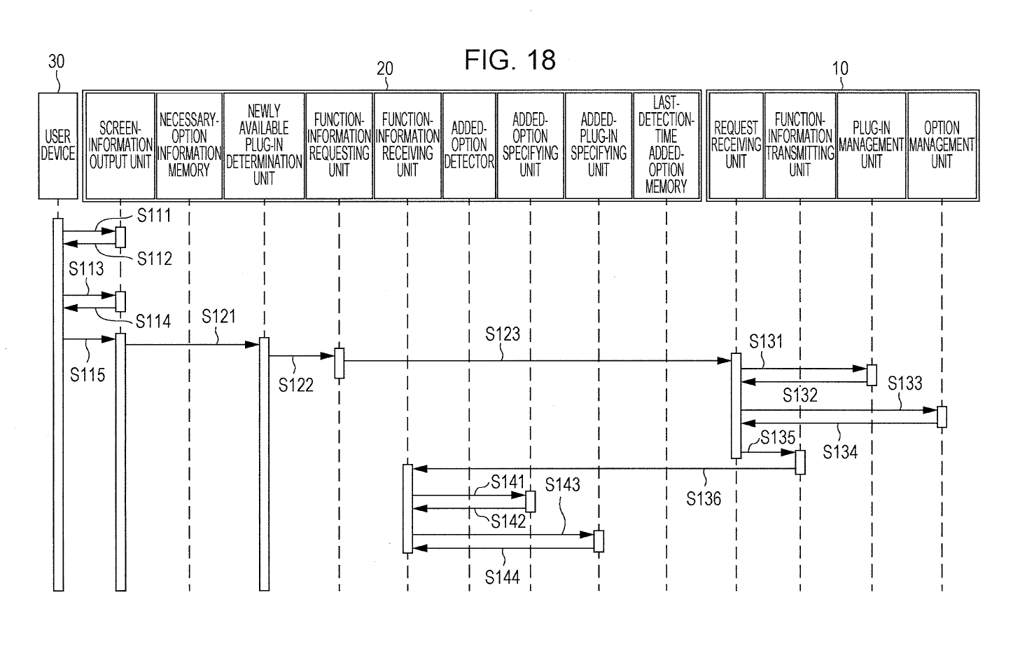

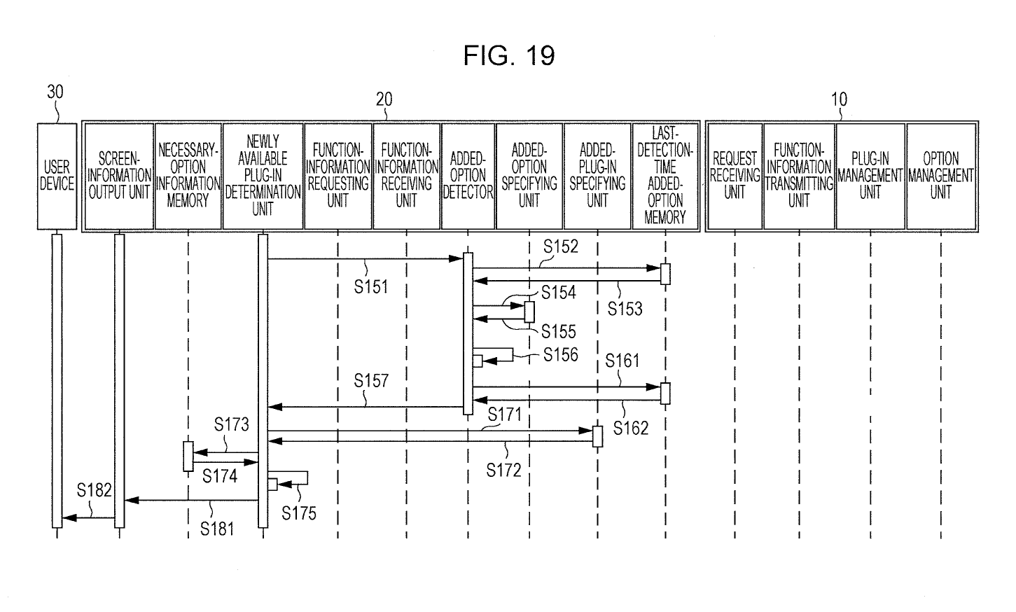

Next, details of the operation from steps S11 (request for display of a plug-in purchase screen) to S18 (output of screen information indicating newly available plug-ins) illustrated in FIG. 15 will be described with reference to FIGS. 18 and 19.

FIG. 18 illustrates details of the operation procedure from steps S11 to S14. First, the user performs an operation for logging in to the certain selling site, and consequently the user device 30 requests a login from the screen-information output unit 209 of the store server device 20 (step S111). The screen-information output unit 209 notifies the user device 30 of the user's authentication result (step S112). Next, the user performs an operation for specifying the image processing device 10, and consequently the user device 30 transmits information indicating the image processing device 10, which has been specified, (for example, a device ID) to the screen-information output unit 209 (step S113). The screen-information output unit 209 transmits, to the user device 30, screen information representing a plug-in management screen for the image processing device 10 as illustrated in FIG. 14A (step S114). The user performs an operation for causing a plug-in purchase screen to be displayed, and consequently the user device 30 requests the screen-information output unit 209 to display the plug-in purchase screen (step S115). Steps S111 to S115 show details of the operation performed in step S11.

Next, the screen-information output unit 209 commands the newly available plug-in determination unit 208 to perform a newly available plug-in determination (step S121). Next, the newly available plug-in determination unit 208 commands the function-information requesting unit 201 to request function information (step S122). The function-information requesting unit 201 requests function information from the image processing device 10 (step S123). Steps S121 to S123 illustrate details of the operation performed in step S12.

Upon receiving a request issued in step S123, the request receiving unit 103 of the image processing device 10 requests a list of added plug-ins from the plug-in management unit 101 (step S131). The plug-in management unit 101 supplies the requested list of added plug-ins to the request receiving unit 103 (step S132). In addition, the request receiving unit 103 requests a list of added options from the option management unit 102 (step S133). The option management unit 102 supplies the requested list of added options to the request receiving unit 103 (step S134). The request receiving unit 103 supplies both of the supplied lists to the function-information transmitting unit 104 (step S135). The function-information transmitting unit 104 generates function information from both of the supplied lists, and transmits the function information to the store server device 20 (step S136). Steps S131 to S136 illustrate details of the operation performed in step S13.

Upon receiving the function information transmitted in step S136, the function-information receiving unit 202 of the store server device 20 supplies the received function information to the added-option specifying unit 204 (step S141). The added-option specifying unit 204 specifies added options of the image processing device 10 from the function information, stores the added options, and notifies the function-information receiving unit 202 that the added options are specified and stored (step S142). Next, the function-information receiving unit 202 supplies the received function information to the added-plug-in specifying unit 203 (step S143). The added-plug-in specifying unit 203 specifies added plug-ins of the image processing device 10 from the function information, stores the added plug-ins, and notifies the function-information receiving unit 202 that the added plug-ins are specified and stored (step S144). Steps S141 to S144 illustrate details of the operation performed in step S14.

FIG. 19 illustrates details of the operation procedure from steps S15 to S18. The newly available plug-in determination unit 208 commands the added-option detector 205 to detect added options (step S151). The added-option detector 205 requests last-time added-option information from the last-detection-time added-option memory 206 (step S152). The last-detection-time added-option memory 206 supplies the requested last-time added-option information to the added-option detector 205 (step S153). Next, the added-option detector 205 requests added-option information from the added-option specifying unit 204 (step S154). The added-option specifying unit 204 supplies the requested added-option information to the added-option detector 205 (step S155). The added-option detector 205 detects an added option in accordance with both of the supplied pieces of information (step S156), and notifies the newly available plug-in determination unit 208 of the supplied added-option information and the detected added option (step S157). Steps S151 to S157 illustrate details of the operation performed in step S15.

The added-option detector 205 supplies the added-option information used in the detection performed in step S156 to the last-detection-time added-option memory 206 (step S161). The last-detection-time added-option memory 206 updates the stored last-time added-option information using the supplied added-option information (step S162). Steps S161 to S162 illustrate details of the operation performed in step S16.

Upon being notified of the added option in step S157, the newly available plug-in determination unit 208 requests added-plug-in information from the added-plug-in specifying unit 203 (step S171). The added-plug-in specifying unit 203 supplies the requested added-plug-in information to the newly available plug-in determination unit 208 (step S172). Next, the newly available plug-in determination unit 208 requests necessary-option information from the necessary-option information memory 207 (step S173). The necessary-option information memory 207 supplies the requested necessary-option information to the newly available plug-in determination unit 208 (step S174). The newly available plug-in determination unit 208 determines newly available plug-ins in accordance with the added-plug-in information and necessary-option information supplied in this manner, and the added-option information and added option for which a notification has been made in step S157 (step S175). Steps S171 to S175 illustrate details of the operation performed in step S17.

Upon determining newly available plug-ins in step S175, the newly available plug-in determination unit 208 notifies the screen-information output unit 209 of the newly available plug-ins (step S181). The screen-information output unit 209 outputs, to the user device 30, screen information indicating the newly available plug-ins for which a notification has been made (step S182). Steps S181 and S182 illustrate details of the operation performed in step S18.

### [2] Modifications

The above-described exemplary embodiment is a mere example of an exemplary embodiment according to the present invention, and may also be modified as in the following. In addition, the above-described exemplary embodiment and each of the following modifications may be combined and performed as necessary.

### [2-1] User Interface

In the exemplary embodiment, the user device 30 is used as a user interface when an option or a plug-in is purchased and added; however, the user interface is not limited to the user device 30, and for example the operation panel unit 14 of the image processing device 10 may also be used. In addition, these user interfaces are used not only for these purchase and addition but also as a user interface for operations in general of the image processing device 10.

### [2-2] Output Destination

The screen-information output unit 209 outputs screen information to the user device 30 in the exemplary embodiment; however, an output destination of screen information is not limited to the user device 30. For example, when the operation panel unit 14 of the image processing device 10 is used as a user interface, the screen-information output unit 209 outputs screen information to the operation panel unit 14. In addition, the screen-information output unit 209 may also output screen information to a destination associated with a user who uses the image processing device 10 such as an e-mail address of the user or a social networking service (SNS) account of the user. In short, the screen-information output unit 209 may output screen information to any output destination as long as the user is able to view a screen represented by the screen information.

### [2-3] Output Timing

In the exemplary embodiment, when a screen for purchasing a plug-in is displayed or a newly available plug-in is added as in the example illustrated in FIG. 15 or when an option is added as in the example illustrated in FIG. 16, the screen-information output unit 209 outputs screen information; however, screen information may also be output at timings other than these timings. For example, the screen-information output unit 209 may also output screen information at timings such as when a user performs an operation for causing newly available plug-ins to be displayed, when a user performs a login, when an added option is used, and when a certain time has passed from a login.

### [2-4] Number of Times Screen Information is Output

The screen-information output unit 209 may also output, not once but plural times, the same screen information indicating a certain newly available plug-in. The screen-information output unit 209 may output screen information, for example, every time a user performs a login or every time the above-described each timing comes. In addition, an upper limit may be set for the number of times screen information is output. In this case, for example, the screen-information output unit 209 outputs screen information every time a user performs a login until the user's Xth login (X is a natural number), and does not output screen information at and after the user's X+1th login.

### [2-5] Appropriately Select and Use Output Method

The screen-information output unit 209 may also appropriately select and use a certain output method among the above-described output methods (an output destination, an output timing, and the number of times screen information is output) as in the following.

[2-5-1] Types of Plug-in

The screen-information output unit 209 outputs, for example, screen information using an output method corresponding to the type of newly available plug-in indicated by the screen information. The screen-information output unit 209 uses an output-method table in which the types of newly available plug-in are associated with output methods.

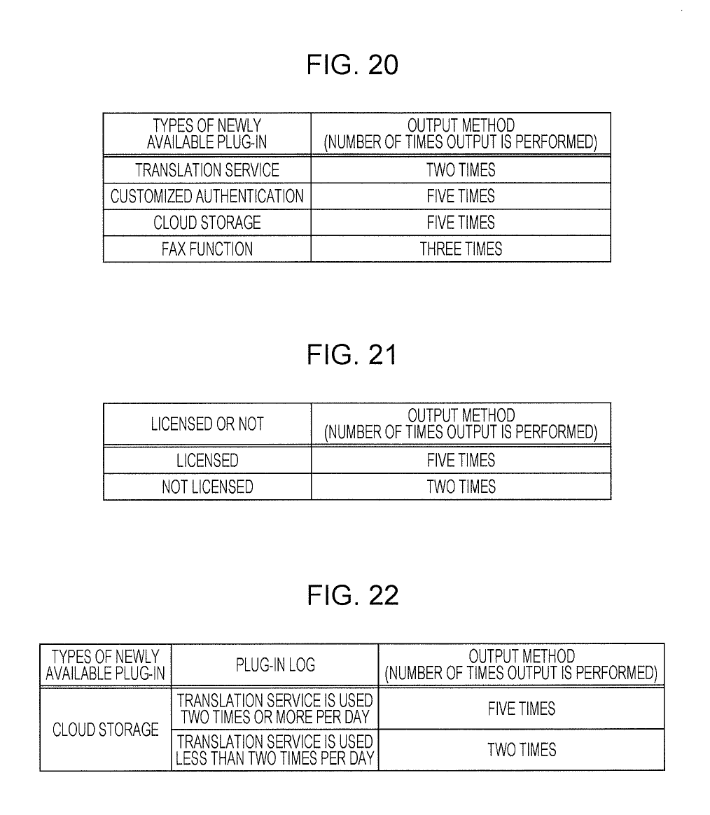

FIG. 20 illustrates an example of an output-method table. In the example illustrated in FIG. 20, the types of newly available plug-in, which are “translation service”, “customized authentication”, “cloud storage”, and “FAX function”, are associated with output methods (in this example, the number of times screen information is output), which are “two times”, “five times”, “five times”, and “three times”, respectively. In the case where the screen-information output unit 209 outputs screen information indicating the “translation service”, the screen-information output unit 209 performs output up to two times, the number of times associated with the “translation service” in this output-method table. In the case where the screen-information output unit 209 outputs screen information indicating the “cloud storage”, the screen-information output unit 209 performs output up to five times, the number of times associated with the “cloud storage” in this output-method table.

Note that not only the number of times screen information is output but also an output destination and an output timing may also be associated in the output-method table. In these cases, too, a certain output destination and an output timing are appropriately selected from among an output destination and an output timing that the user is likely to recognize, and other output destinations and output timings are used.

[2-5-2] Licensed or not

The screen-information output unit 209 outputs screen information, which indicates a newly available plug-in, using an output method corresponding to whether or not use of the newly available plug-in is licensed (that is, whether or not the newly available plug-in is licensed). The screen-information output unit 209 uses an output-method table in which whether or not use of a newly available plug-in is licensed is associated with an output method.

FIG. 21 illustrates another example of an output-method table. In the example illustrated in FIG. 21, in the case where use of a certain plug-in is licensed (in the case of “licensed”), its output method (in this example, the number of times screen information is output) indicates “five times”. In the case where use of a certain plug-in is not licensed (in the case of “not licensed”), its output method indicates “two times”. The screen-information output unit 209 makes, for example, an inquiry to a license management server that manages license rights of plug-ins, and confirms whether or not use of a newly available plug-in is licensed to the image processing device 10. In a case where it is confirmed that use of the newly available plug-in is licensed, the screen-information output unit 209 outputs screen information up to “five times”, the number of times associated with “licensed” in this output-method table. In a case where it is confirmed that use of the newly available plug-in is not licensed, the screen-information output unit 209 outputs screen information up to “two times”, the number of times associated with “not licensed” in this output-method table.

In the example illustrated in FIG. 21, a certain output method among different output methods is appropriately selected and used so that the more easily the plug-in use of which is licensed may be added, the higher the probability of the plug-in to be added. Note that in contrast, the number of times screen information is output is increased for a plug-in that tends not to be added because use of the plug-in is not licensed and a license needs to be purchased for the plug-in, and a certain output method may be appropriately selected from among different output methods and used so that the probability of addition of such a plug-in is increased as much as possible. In either case, for newly available plug-ins, how easily each of the newly available plug-ins gains recognition to a user varies in accordance with whether or not use of the newly available plug-in is licensed.

[2-5-3] Log

The screen-information output unit 209 outputs screen information using an output method corresponding to a log of plural plug-ins for the image processing device 10. As a log, for example, the frequency of use of each plug-in is used. The screen-information output unit 209 uses an output-method table in which a type of newly available plug-in, a plug-in log, and an output method are associated with each other.

FIG. 22 illustrates another example of an output-method table. In the case where the type of newly available plug-in is “cloud storage”, this output-method table shows that the number of times screen information is output is “five times” for “frequency of use of translation service is two times or more per day”, and the number of times screen information is output is “two times” for “frequency of use of translation service is less than two times per day”.

In this example, for example, the plug-in management unit 101 of the image processing device 10 stores the frequency of use of each plug-in, and the function-information transmitting unit 104 transmits function information including this frequency of use to the store server device 20. When the frequency of use of the “translation service” indicated by the received function information is “two times or more per day”, the screen-information output unit 209 outputs screen information up to “five times” associated with the frequency of use in the output-method table. When the frequency of use of the “translation service” is “less than two times per day”, the screen-information output unit 209 outputs screen information up to “two times” associated with the frequency of use in the output-method table.

Note that since the “translation service” is a service for translating scanned characters, use of the “translation service” may also include use of the “scan option”. The “translation service” is a function having necessary options (the “scan option” and the “memory add-on option”) in common with the “cloud storage”, which is a newly available plug-in. The “scan option” is a necessary option common to the “translation service” and the “cloud storage”. That is, the screen-information output unit 209 outputs information representing the “cloud storage” when another function associated with this “cloud storage” (the “translation service” or the “scan option”) is used in the above-described example.

The higher the frequency of use of the translation service becomes, the larger the memory area tends to be needed. In the example illustrated in FIG. 22, in a case where a larger memory area is needed in such a manner, a certain output method among different output methods is appropriately selected and used so that the probability of addition of a cloud-storage plug-in, which increases a memory area, is increased. Note that in a case, which is other than this case, where another plug-in increases in need by using a certain plug-in, a certain output method among different output methods may be appropriately selected and used likewise. In contrast, for example, in a case where a plug-in B decreases in need by using a plug-in A, the higher the frequency of use of the plug-in A, the less the number of times screen information is output for the case where the plug-in B is a newly available plug-in.

Note that the numbers of times regarding output illustrated in the example illustrated in FIG. 22 are examples, and the numbers of times regarding output may be changed and output may be performed. In addition, not only the number of times screen information is output is changed in accordance with a log, but also whether or not screen information is output may also be changed in accordance with a log. For example, the screen-information output unit 209 outputs screen information when the frequency of use of the “translation service” indicated by the received function information is “two times or more per day”, and does not output screen information when the frequency of use of the “translation service” is “less than two times per day”. In addition, the screen-information output unit 209 may also output screen information indicating a newly available plug-in in a case where another function associated with the newly available plug-in is used.

In addition, in a case where there are plural newly available plug-ins, among pieces of screen information indicating the respective plural newly available plug-ins, the screen-information output unit 209 may output in a more prioritized manner a piece of screen information indicating a newly available plug-in for which another function associated with the newly available plug-in is used than a piece of screen information indicating a newly available plug-in for which another function associated with the newly available plug-in is not used. In this case, for the plural newly available plug-ins, how easily each of the plural newly available plug-ins gains recognition to a user varies in accordance with whether or not another function associated with the newly available plug-in is used.

For example, in the case where both the “customized authentication” and the “FAX function” are newly available plug-ins, where the “customized option” associated with the “customized authentication” is used, and where any of the functions associated with the “FAX function” (necessary options, and other plug-ins with which the “FAX function” has a certain necessary option in common) is not used, the screen-information output unit 209 outputs screen information indicating the “customized authentication” in a more prioritized manner than screen information indicating the “FAX function”. The expression “output in a more prioritized manner” here indicates that, for example, the frequency of output is increased or a timing at which output is performed is set earlier.

[2-5-4] Log of Another Device

Regarding the following example, assume that another image processing device other than the image processing device 10 is present.

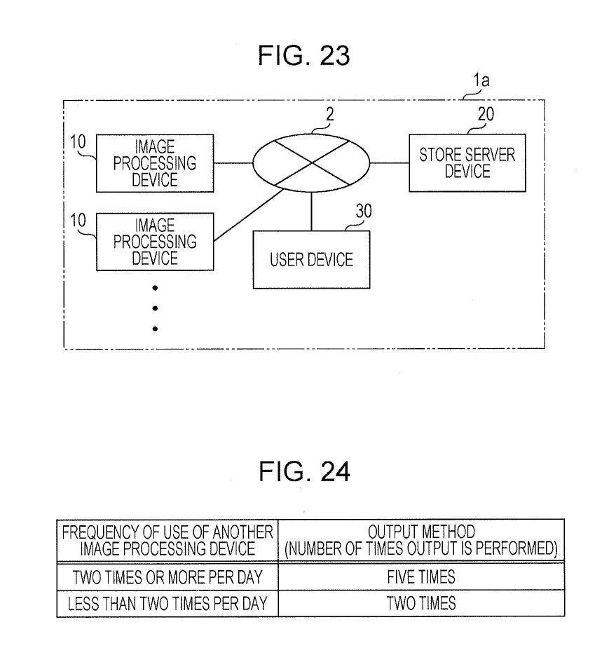

FIG. 23 illustrates an example of the entire configuration of an information processing system 1a according to the present modification. The information processing system 1a includes plural image processing devices 10. Any of the plural image processing devices 10 is a device to which it is possible to add the above-described options and plug-ins, and is installed, for example, for each department of an office.

In this information processing system 1a, the screen-information output unit 209 of the store server device 20 outputs screen information using an output method corresponding to a log of another image processing device 10 regarding a user who uses an image processing device 10. As this log, for example, the frequency of use of the other image processing device 10 is used. The screen-information output unit 209 uses an output-method table in which this frequency of use is associated with an output method.

FIG. 24 illustrates another example of an output-method table. The example illustrated in FIG. 24 shows that the number of times screen information is output is “five times” when the frequency of use of the other image processing device 10 is “two times or more per day”, and the number of times screen information is output is “two times” when the frequency of use of the other image processing device 10 is “less than two times per day”.

In this example, for example, each image processing device 10 stores login dates and times of each user, and the function-information transmitting unit 104 transmits function information including these login dates and times to the store server device 20. For each image processing device 10, the screen-information output unit 209 calculates, from login dates and times at which a user who uses the user device 30 has logged in to the image processing device 10, the number of times the image processing device 10 is logged in per day as the frequency of use. The screen-information output unit 209 outputs screen information the number of times regarding output associated with the calculated frequency of use in the output-method table.

A user who uses the other image processing device 10 is likely to use a newly available plug-in represented by screen information at the other image processing device 10, and there is no possibility that a user who does not use the other image processing device 10 uses a newly available plug-in represented by screen information at the other image processing device 10.

Note that in order to cause all the users to recognize a newly available plug-in, the number of times screen information is output for users who do not use another image processing device 10 may be made higher than the number of times screen information is output for users who use another image processing device 10. In addition, the frequency of use of another image processing device 10 to which a newly available plug-in is added may also be used as a log of another image processing device 10. In this case, the number of times screen information is output for users who are more likely to have used a newly available plug-in is increased or reduced.

In addition, for example, in a case where a user who uses an image processing device 10 to which a plug-in C has been added uses an option associated with the plug-in C at another image processing device 10 (for example, in the case where the plug-in C is the “translation service”, and the scan option is used at another image processing device 10), the screen-information output unit 209 may output screen information indicating a newly available plug-in. In this case, too, the number of times screen information is output for users who have used a newly available plug-in is increased.

In addition, the numbers of times regarding output illustrated in the example illustrated in FIG. 24 are examples, and the numbers of times regarding output may be changed and output may be performed. In addition, not only the number of times screen information is output is changed in accordance with a log of another image processing device 10, but also whether or not screen information is output may also be changed in accordance with the log. For example, the screen-information output unit 209 outputs screen information indicating a newly available plug-in when the frequency of use of another image processing device 10 represented by the received function information is “two times or more per day”, and does not output screen information indicating a newly available plug-in when the frequency of use of the other image processing device 10 is “less than two times per day”. In addition, the screen-information output unit 209 may also output screen information indicating a newly available plug-in for a certain image processing device 10 in a case where another function associated with the newly available plug-in is used at another image processing device 10.

In addition, in a case where there are plural newly available plug-ins at an image processing device 10, among pieces of screen information indicating the respective plural newly available plug-ins, the screen-information output unit 209 may output in a more prioritized manner a piece of screen information indicating a newly available plug-in for which another function associated with the newly available plug-in is used at another image processing device 10 than a piece of screen information indicating a newly available plug-in for which another function associated with the newly available plug-in is not used at another image processing device 10. In this case, for the plural newly available plug-ins, how easily each of the plural newly available plug-ins gains recognition to a user varies in accordance with whether or not another function associated with the newly available plug-in is used at another image processing device 10.

For example, in the case where both the “customized authentication” and the “FAX function” are newly available plug-ins at a certain image processing device 10, where the “customized option” associated with the “customized authentication” is used at another image processing device 10, and where any of the functions associated with the “FAX function” (necessary options, and other plug-ins with which the “FAX function” has a certain necessary option in common) is not used at another image processing device 10, the screen-information output unit 209 outputs in a more prioritized manner screen information indicating the “customized authentication” than screen information indicating the “FAX function”.

### [2-6] Output to Medium

Screen information may also be output to mediums such as paper sheets. When screen information is output from the screen-information output unit 209 of the store server device 20, the image forming unit 16 of the image processing device 10 of the present modification forms an image represented by the output screen information on a medium. Then, the screen-information output unit 209 outputs the screen information to the image forming unit 16 when a user who uses the image processing device 10 is at an installation location of the image processing device 10.

For example, in a case where the user device 30 is used as a user interface, the screen-information output unit 209 determines that the user is not at the installation location of the image processing device 10. In the case where the operation panel unit 14 is used, the screen-information output unit 209 determines that the user is at the installation location of the image processing device 10. In the case where it is determined that the user is not at the installation location of the image processing device 10, the screen-information output unit 209 sets the user device 30, which is a user interface, as an output destination of screen information. In the case where it is determined that the user is at the installation location of the image processing device 10, the screen-information output unit 209 sets as an output destination of screen information not the operation panel unit 14, which is a user interface, but the image forming unit 16. Note that in the latter case, the screen information may also be output to the operation panel unit 14 in addition to the image forming unit 16.

### [2-7] Information to be Output

In the exemplary embodiment the screen information representing a screen of the selling site output by the screen-information output unit 209 (for example, the screen illustrated in FIG. 14B) is an example of information representing plug-ins (newly available plug-ins) that become available by addition of an added option. In addition to this, for example, an ID assigned to a newly available plug-in may also be output, or information regarding a sound representing the name of a newly available plug-in may also be output. In short, any type of information may also be output as long as it is information representing a plug-in that has become available by addition of an added option.

In addition to information representing a newly available plug-in, necessary-option information representing an option that makes the plug-in represented by the information available (that is, the above-described necessary option) may also be output. The screen-information output unit 209 refers to, for example, the necessary-option information illustrated in FIG. 12, and outputs screen information indicating necessary options associated with a certain newly available plug-in. Note that the added-option detector 205 may notify the screen-information output unit 209 of a detected added option, and consequently the screen-information output unit 209 may output information indicating which one of the necessary options is an added option.

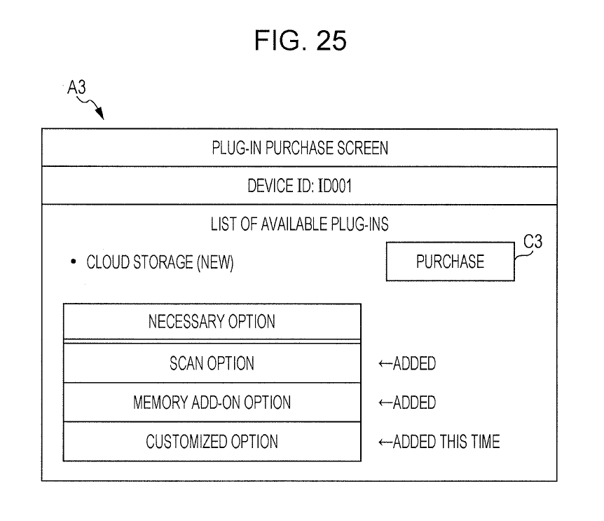

FIG. 25 illustrates an example of a screen displaying necessary-option information. In FIG. 25, “cloud storage (New)” is displayed in a list of available plug-ins of a certain selling site. “Scan option” and “memory add-on option” are displayed as “necessary option” together with a character string of “added”, and “customized option” is displayed together with a character string of “added this time”.

Note that the screen-information output unit 209 may output necessary-option information to a specific user instead of to all the users. In the case where, for example, the user who uses a certain image processing device 10 is a user who uses another image processing device 10 to which an option that has made a newly available plug-in available is not added, the screen-information output unit 209 outputs the above-described necessary-option information. In this case, the screen-information output unit 209 specifies an image processing device 10 that the user uses, in accordance with, for example, information regarding the login dates and times described using FIGS. 23 and 24. In the case where even one image processing device 10 to which a certain necessary option is not added is specified, the screen-information output unit 209 outputs necessary-option information to the user device 30 of the user.

### [2-8] Devices Realizing Units and Functional Configuration

The devices that realize the notification unit, the specifying unit, the detector, and the output unit illustrated in FIG. 5 and the units equipped with these devices are not limited to those illustrated in FIG. 5. For example, as the specifying unit, not only the added-plug-in specifying unit 203 but also the function-information requesting unit 201 and the function-information receiving unit 202 may cooperate with each other and may serve as a specifying unit. In addition, the specifying unit and the detector may be realized by the image processing device 10, or may also be realized by another server device provided in addition to the store server device 20. In short, as long as the above-described units are realized, hardware devices that realize these units and functions may have any configuration.

### [2-9] First Function and Second Function

It has been described in the exemplary embodiment that options are an example of plural types of first function, and plug-ins are an example of plural types of second function; however, first functions and second functions are not limited to these. For example, something called extensions, additional programs, add-ons, and the like may also be used as first functions and second functions. Each of the first functions and second functions may be realized using both a hardware device and a software program, or may also be realized using either one of a hardware device and a software program. In short, when there is a relationship such that plural types of second function include a type of second function that becomes available in the case where any of plural types of first function has been added, any functions may be used as first functions and second functions.

### [2-10] Information Processing Device

It has been described in the exemplary embodiment that the image processing devices are an example of information processing devices in the present invention; however, the present invention may also be applied to information processing devices other than these image processing devices. For example, the present invention is applicable even to information processing devices such as automated teller machines (ATMs), kiosk terminals, and point-of-sale (POS) terminals installed at shops and the like as long as these information processing devices are devices to which it is possible to add plural types of first function (the options in the exemplary embodiment) and plural types of second function (the plug-ins in the exemplary embodiment), the plural types of second function including a second function that becomes available in the case where any of the plural types of first function has been added.

### [2-11] Category of Invention

The present invention may be viewed as a management device that manages an information processing device such as the image processing device 10, a user devices, and an information processing device such as the store server device 20. In addition, the present invention may also be viewed as an information processing system including these devices, and may also be viewed as an information processing method for realizing processes performed by these devices. In addition, the present invention may also be viewed as a program for causing computers, which are an information processing device, a user device, and a management device, to serve as the above-described units. This program may be provided using a recording medium such as an optical disc on which the program is stored, or may also be provided so that the program is downloaded and installed into a computer via a communication line such as the Internet, the program being enabled by installation.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A management device comprising:
an output unit that outputs, in a case where any first function has been added among a plurality of types of first function to an information processing device, information representing a second function obtained by excluding, from a plurality of second functions that have become available by this addition, a second function that has been added to the information processing device, the information processing device being an information processing device to which it is possible to add the plurality of types of first function and the plurality of types of second function, the plurality of types of second function including a second function that becomes available in a case where any of the plurality of types of first function has been added.

2. The management device according to claim 1,
wherein the output unit outputs, in a case where use of the second function represented by the information is licensed, the information representing the second function obtained by excluding the second function that has been added to the information processing device from the second functions that have become available.

3. The management device according to claim 1,
wherein the output unit outputs the information representing the second function in a case where another function associated with the second function is used.

4. The management device according to claim 2,
wherein the output unit outputs the information representing the second function in a case where another function associated with the second function is used.

5. The management device according to claim 1,
wherein the output unit outputs the information representing the second function in a case where another function associated with the second function is used at another information processing device.

6. The management device according to claim 2,
wherein the output unit outputs the information representing the second function in a case where another function associated with the second function is used at another information processing device.

7. The management device according to claim 1,
wherein in a case where the second functions that have become available are a plurality of second functions, among pieces of information representing the plurality of respective second functions, the output unit outputs in a more prioritized manner a piece of information representing a second function for which another function associated with the second function is used than a piece of information representing a second function for which another function associated with the second function is not used.

8. The management device according to claim 2,
wherein in a case where the second functions that have become available are a plurality of second functions, among pieces of information representing the plurality of respective second functions, the output unit outputs in a more prioritized manner a piece of information representing a second function for which another function associated with the second function is used than a piece of information representing a second function for which another function associated with the second function is not used.

9. The management device according to claim 1,
wherein in a case where the second functions that have become available at the information processing device are a plurality of second functions, among pieces of information representing the plurality of respective second functions, the output unit outputs in a more prioritized manner a piece of information representing a second function for which another function associated with the second function is used at another information processing device than a piece of information representing a second function for which another function associated with the second function is not used at another information processing device.

10. The management device according to claim 2,
wherein in a case where the second functions that have become available at the information processing device are a plurality of second functions, among pieces of information representing the plurality of respective second functions, the output unit outputs in a more prioritized manner a piece of information representing a second function for which another function associated with the second function is used at another information processing device than a piece of information representing a second function for which another function associated with the second function is not used at another information processing device.

11. The management device according to claim 1,
wherein an output method for the information representing the second function includes the number of times the information is output, an output timing, or an output destination.

12. The management device according to claim 2,
wherein an output method for the information representing the second function includes the number of times the information is output, an output timing, or an output destination.

13. The management device according to claim 1, wherein
the information processing device includes an image forming unit that forms an image represented by the output information on a medium, and
the output unit outputs, in a case where a user who uses the information processing device is at an installation location of the information processing device, the information representing the second function to the image forming unit.

14. The management device according to claim 2, wherein
the information processing device includes an image forming unit that forms an image represented by the output information on a medium, and
the output unit outputs, in a case where a user who uses the information processing device is at an installation location of the information processing device, the information representing the second function to the image forming unit.

15. The management device according to claim 1,
wherein the output unit outputs, in addition to the information representing the second function, information representing the first function that makes the second function represented by the information available.

16. The management device according to claim 2,
wherein the output unit outputs, in addition to the information representing the second function, information representing the first function that makes the second function represented by the information available.

17. The management device according to claim 15,
wherein the output unit outputs information representing the first function in a case where a user who uses the information processing device is a user who uses another information processing device to which the first function that has made the second function represented by the information available is not added.

18. The management device according to claim 16,
wherein the output unit outputs information representing the first function in a case where a user who uses the information processing device is a user who uses another information processing device to which the first function that has made the second function represented by the information available is not added.

19. An information processing system comprising:
a management device including an output unit that outputs, in a case where any first function has been added among a plurality of types of first function to an information processing device, information representing a second function obtained by excluding, from a plurality of second functions that have become available by this addition, a second function that has been added to the information processing device, the information processing device being an information processing device to which it is possible to add the plurality of types of first function and the plurality of types of second function, the plurality of types of second function including a second function that becomes available in a case where any of the plurality of types of first function has been added; and
an information processing device to which it is possible to add the plurality of types of first function and the plurality of types of second function, and that includes a notification unit that notifies the management device of a first function added to the information processing device among the plurality of types of first function.

20. A non-transitory computer readable medium storing a program causing a computer to execute a process, the process comprising:
outputting, in a case where any first function has been added among a plurality of types of first function to an information processing device, information representing a second function obtained by excluding, from a plurality of second functions that have become available by this addition, a second function that has been added to the information processing device, the information processing device being an information processing device to which it is possible to add the plurality of types of first function and the plurality of types of second function, the plurality of types of second function including a second function that becomes available in a case where any of the plurality of types of first function has been added.
